(19) United States
(12) Patent Application Publication
(10) Pub. No.: US 2026/0198454 A1
(43) Pub. Date: Jul. 16, 2026

(54) PET COMB

(71) Applicant: Jiangsu Wellspring PET Articles Co., Ltd., Yancheng (CN)

(72) Inventor: Bin QIU, Yancheng (CN)

(21) Appl. No.: 19/417,257

(22) Filed: Dec. 11, 2025

(30) Foreign Application Priority Data
Jan. 16, 2025 (CN) 202520103162.1

(51) Int. Cl. A01K 13/00

(52) U.S. Cl. CPC A01K 13/002

(57) ABSTRACT

A pet comb includes a comb body, an accommodating cavity being provided in the comb body and an opening being provided at an end of the comb body; a first connection portion connected to a side of the comb body; a second connection portion, a connection groove being provided in the second connection portion and the first connection portion being slidably connected to an interior of the connection groove; a comb-tooth member, a first end of the comb-tooth member being arranged in the accommodating cavity and a second end of the comb-tooth member extending out through the opening; a sliding member, a first end of the sliding member being arranged in the accommodating cavity, a second end of the sliding member being configured to extend out through the opening, and the sliding member being in contact with the comb-tooth member; and an adjustment assembly arranged in the accommodating cavity.

### CROSS REFERENCE TO THE RELATED APPLICATIONS

This application is based upon and claims priority to Chinese Patent Application No. 202520103162.1, filed on January 16, 2025, the entire contents of which are incorporated herein by reference.

### TECHNICAL FIELD

The present disclosure relates to the field of pet supplies, and in particular, to a pet comb.

### BACKGROUND

With an increase of people's life pressure, more and more people like to alleviate the pressure by keeping pets. In the process of keeping pets, hair of the pets needs to be combed. However, for most existing pet combs, hair may stick to various parts of a comb-tooth member during use, and the various parts of the comb-tooth member need to be manually cleaned, increasing the difficulty of cleaning up the hair.

### SUMMARY

In order to solve the technical problem that for most existing pet combs, hair may stick to various parts of a comb-tooth member during use, and the various parts of the comb-tooth member need to be manually cleaned, increasing the difficulty of cleaning up the hair, an objective of the present disclosure is to provide a pet comb.

In order to achieve the above objective, an embodiment of the present disclosure provides a pet comb, including:

a comb body, where an accommodating cavity is provided in the comb body, and an opening is provided at a first end of the comb body;

a first connection portion, where the first connection portion is connected to a side of the comb body;

a second connection portion, where a connection groove is provided in the second connection portion, and the first connection portion is slidably connected to an interior of the connection groove;

a comb-tooth member, where a first end of the comb-tooth member is arranged in the accommodating cavity, and a second end of the comb-tooth member extends out through the opening;

a sliding member, where a first end of the sliding member is arranged in the accommodating cavity, a second end of the sliding member is configured to extend out through the opening, and the sliding member is in contact with the comb-tooth member; and

an adjustment assembly, where the adjustment assembly is arranged in the accommodating cavity.

In the above technical solution, the adjustment assembly includes:

a groove, where the groove is provided on a side of the sliding member adjacent to the comb-tooth member and is arranged at the first end of the sliding member away from the opening;

a first fixing member, where a first end of the first fixing member is connected to an inner wall of the comb body, and a second end of the first fixing member extends through the sliding member and the comb-tooth member;

a first slide groove, where the first slide groove is provided at a bottom of the groove, and the first fixing member extends through the first slide groove;

a second slide groove, where the second slide groove is provided at the bottom of the groove;

an adjustment member, where a first end of the adjustment member is arranged in the groove and is rotatably connected to the first fixing member, a protrusion is connected to a side of the adjustment member away from the comb-tooth member and is slidably connected to an interior of the second slide groove, and a second end of the adjustment member extends through a second end of the comb body away from the opening;

a third slide groove, where the third slide groove is provided on the sliding member;

a second fixing member, where the second fixing member is connected to the inner wall of the comb body and extends through the third slide groove; and

a spring, where a first end of the spring is connected to a side wall of the third slide groove, and a second end of the spring is connected to the second fixing member.

In the above technical solution, a third fixing member is fixedly connected to the inner wall of the comb body, a fourth slide groove is provided on the sliding member, the third fixing member extends through the fourth slide groove and the comb-tooth member, and the third fixing member is slidably connected to an interior of the fourth slide groove.

In the above technical solution, a limiting groove is provided on a side wall of the first connection portion, a locking structure is arranged inside the connection groove, and the limiting groove is configured to be engaged with the locking structure.

In the above technical solution, a positioning surface is arranged on a side wall of the first connection portion, and a cross-sectional shape of the first connection portion conforms to a cross-sectional shape of the connection groove.

Additional aspects and advantages of the present disclosure will become apparent in the following description, or be understood from the practice of the present disclosure.

### BRIEF DESCRIPTION OF THE DRAWINGS

The above and/or additional aspects and advantages of the present disclosure will become apparent and more readily appreciated from the following description made with reference to the drawings.

FIG. 1 is a schematic overall structural diagram of a comb body according to an embodiment of the present disclosure.

FIG. 2 is a schematic sectional structural diagram of a comb body according to an embodiment of the present disclosure.

FIG. 3 is a schematic internal structural diagram of a comb body according to an embodiment of the present disclosure.

FIG. 4 is a schematic internal structural diagram of a comb body without a comb-tooth member according to an embodiment of the present disclosure.

FIG. 5 is a schematic structural diagram of a sliding member in engagement with an adjustment member according to an embodiment of the present disclosure.

FIG. 6 is a schematic structural diagram of a comb body according to an embodiment of the present disclosure.

FIG. 7 is a schematic structural diagram of a second connection portion according to an embodiment of the present disclosure.

### DETAILED DESCRIPTION OF THE EMBODIMENTS

In order to understand the above objects, features, and advantages of the present disclosure more clearly, the present disclosure is further described in detail below in conjunction with the accompanying drawings and specific embodiments. It should be noted that the embodiments in the present application and features in the embodiments may be combined with each other without conflicts.

In the following description, numerous specific details are set forth to facilitate a full understanding of the present disclosure; however, the present disclosure may be implemented in other ways than those described herein, and therefore, the scope of protection of the present disclosure is not limited by the specific embodiments disclosed below.

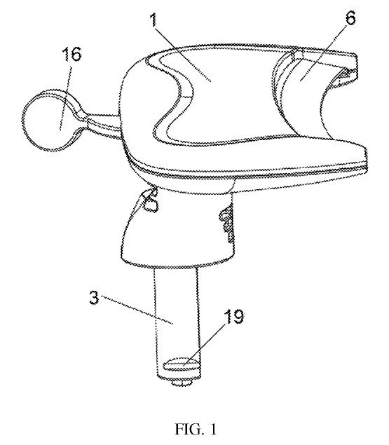

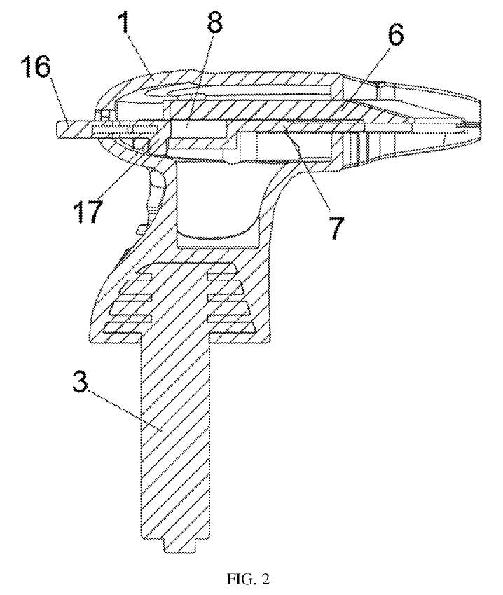

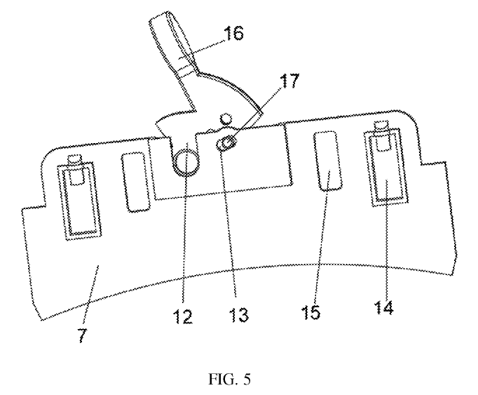

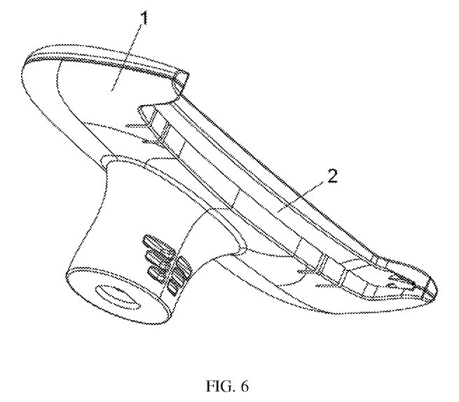

Some embodiments of a pet comb according to the present disclosure are described below with reference to FIG. 1 to FIG. 7.

As shown in FIG. 1 to FIG. 7, an embodiment of the present disclosure provides a pet comb, including a comb body 1, a first connection portion 3, a second connection portion 4, a comb-tooth member 6, a sliding member 7, and an adjustment assembly.

Specifically, an accommodating cavity is provided in the comb body 1, and an opening 2 is provided at a first end of the comb body 1.

The first connection portion 3 is fixedly connected to a side of the comb body 1.

A connection groove 5 is provided in the second connection portion 4, and the first connection portion 3 is slidably connected to an interior of the connection groove 5.

A first end of the comb-tooth member 6 is arranged in the accommodating cavity, a second end of the comb-tooth member 6 extends out through the opening 2, and the comb-tooth member 6 is fixed in the accommodating cavity.

A first end of the sliding member 7 is arranged in the accommodating cavity, a second end of the sliding member 7 is configured to extend out through the opening 2, the sliding member 7 is arranged on a side of the comb-tooth member 6 adjacent to the first connection portion 3, and the sliding member 7 is in contact with the comb-tooth member 6.

The adjustment assembly is arranged in the accommodating cavity, and an end of the adjustment assembly extends out of the comb body 1.

When combing of hair of a pet is completed, the user pushes the adjustment assembly extending out of the comb body 1, the adjustment assembly drives the sliding member 7 to move towards the opening 2, and since the sliding member 7 is in contact with the comb-tooth member 6, the hair stuck on the comb-tooth member 6 can be moved away from the opening 2 during the movement of the sliding member 7, the hair is then gathered at the end portion of the comb-tooth member 6 away from the comb body 1, and the user can directly remove the hair, making the cleaning up of the hair simpler.

The first connection portion 3 is fixedly connected to the side of the comb body 1, so that the first connection portion 3 may be inserted into the connection groove 5 of the second connection portion 4. The first connection portion 3 and the second connection portion 4 are connected to each other to serve as a handle for the user to hold by hand, facilitating the user to hold the whole pet comb by hand.

Through the adjustment assembly, the hair on the comb-tooth member 6 can be gathered at the end portion of the comb-tooth member 6 away from the comb body 1, facilitating the user to collect the hair.

As shown in FIG. 1 to FIG. 6, in an embodiment of the present disclosure, the adjustment assembly includes a groove 8, a first fixing member 9, a first slide groove 12, a second slide groove 13, an adjustment member 16, two third slide grooves 14, second fixing members 10, and springs 18.

The groove 8 is provided on a side of the sliding member 7 adjacent to the comb-tooth member 6 and is arranged at the first end of the sliding member 7 away from the opening 2. An end of the groove 8 away from the opening 2 is open, and the end of the groove 8 away from the opening 2 is flush with the first end of the sliding member 7 away from the opening 2.

A first end of the first fixing member 9 is fixedly connected to an inner wall of the comb body 1 on a side adjacent to the first connection portion 3, and a second end of the first fixing member 9 extends through the sliding member 7 and the comb-tooth member 6.

The first slide groove 12 is provided at a bottom of the groove 8, and the first fixing member 9 extends through the first slide groove 12 and is slidably connected to the first slide groove 12.

The second slide groove 13 is provided at the bottom of the groove 8.

A first end of the adjustment member 16 is arranged in the groove 8 and is rotatably connected to the first fixing member 9, a protrusion 17 is fixedly connected to a side of the adjustment member 16 away from the comb-tooth member 6 and is slidably connected to an interior of the second slide groove 13, and a second end of the adjustment member 16 extends through a second end of the comb body 1 away from the opening 2.

The two third slide grooves 14 are provided on the sliding member 7, and the two third slide grooves 14 are respectively arranged on two sides of the groove 8.

The second fixing members 10 are fixedly connected to the inner wall of the comb body 1 on the side adjacent to the first connection portion 3, and each of the second fixing members 10 extends through a respective one of the two third slide grooves 14 and is slidably connected to an interior of the respective one of the two third slide grooves 14.

A first end of each of the springs 18 is fixedly connected to a side wall of a respective one of the two third slide grooves 14, and a second end of each of the springs 18 is fixedly connected to a respective one of the second fixing members 10.

Third fixing members 11 are fixedly connected to the inner wall of the comb body 1 on the side adjacent to the first connection portion 3. Two fourth slide grooves 15 are provided on the sliding member 7. The two fourth slide grooves 15 are respectively arranged on the two sides of the groove 8. Each of the third fixing members 11 extends through a respective one of the two fourth slide grooves 15 and the comb-tooth member 6, and each of the third fixing members 11 is slidably connected to an interior of the respective one of the two fourth slide grooves 15.

After the combing of the hair of the pet is completed, the user pushes the end of the adjustment member 16 away from the comb body 1 to the left, the adjustment member 16 then rotates around the first fixing member 9 as a center. In the rotating process, the adjustment member 16 drives the protrusion 17 to rotate, and the movement trajectory of the protrusion 17 is an arc line. The angle of the second slide groove 13 is adapted to the movement trajectory of the protrusion 17, and the width of the second slide groove 13 is equal to the diameter of the protrusion 17. The protrusion 17 is always in contact with the second slide groove 13, so that the protrusion 17 can push the sliding member 7 to slowly move out of the opening 2 during the movement of the protrusion 17 along the second slide groove 13, and the hair on the comb-tooth member 6 can be pushed to the end portion of the comb-tooth member 6 away from the comb body 1 during the movement of the sliding member 7, facilitating the user to collect the hair.

When the sliding member 7 has not started to move, the first fixing member 9 is located at an end of the first slide groove 12 adjacent to the opening 2, each of the second fixing members 10 is located at an end of a respective one of the two third slide grooves 14 adjacent to the opening 2, and each of the third fixing members 11 is located at an end of a respective one of the two fourth slide grooves 15 adjacent to the opening 2. Therefore, when the sliding member 7 moves towards the opening 2, the two third slide grooves 14 move towards the opening 2, and since a first end of each of the springs 18 is fixedly connected to an end of a respective one of the two third slide grooves 14 away from the opening 2, and a second end of each of the springs 18 is fixedly connected to a respective one of the second fixing members 10, the two third slide grooves 14 and the second fixing members 10 may respectively compress the springs 18. When the hair is gathered at the end portion of the comb-tooth member 6 away from the comb body 1, the adjustment member 16 is released, the springs 18 return to the original shape to drive the adjustment member 16 to return to the original position, and therefore, when cleaning up the hair, the user only needs to push the adjustment member 16, making operation simple and convenient.

The two fourth slide grooves 15 are respectively provided on the two sides of the groove 8, each of the third fixing members 11 extends through a respective one of the two fourth slide grooves 15 and is slidably connected to an interior of the respective one of the two fourth slide grooves 15, and the outer diameter of each of the third fixing members 11 is equal to the width of the respective one of the two fourth slide grooves 15, so that each of the third fixing members 11 is in contact with the inner wall of the respective one of the two fourth slide grooves 15. Therefore, when the sliding member 7 moves closer to the opening 2, the stability of the sliding member 7 can be improved, preventing the sliding member 7 from deviating in the accommodating cavity.

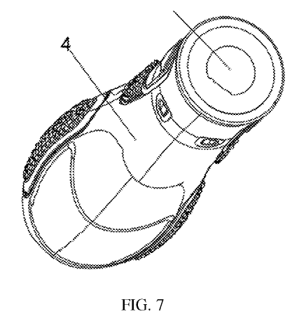

As shown in FIG. 1 and FIG. 7, in an embodiment of the present disclosure, two limiting grooves 19 are symmetrically provided on a side wall of the first connection portion 3, a locking structure is arranged inside the connection groove 5, and the two limiting grooves 19 are configured to be engaged with the locking structure.

When the first connection portion 3 is inserted into the connection groove 5, a spring in the locking structure is deformed to drive the locking structure to be deformed. When the two limiting grooves 19 move to the locking structure, the spring returns to the original shape to drive the locking structure to move into the two limiting grooves 19, and the locking structure is engaged with the two limiting grooves 19, so that the first connection portion 3 is connected to the second connection portion 4. Alternatively, a manual locking structure can be selected. A locking assembly is pressed, the first connection portion 3 is then smoothly inserted into the connection groove 5. After the first connection portion 3 is completely inserted into the connection groove 5, the locking structure is positioned opposite to the two limiting grooves 19, and then, the locking structure is released, and the locking structure enters the two limiting grooves 19, so as to realize the connection of the first connection portion 3 and the second connection portion 4. Both of the above-mentioned locking structures are conventional in the prior art, and the specific working principles are not elaborated herein.

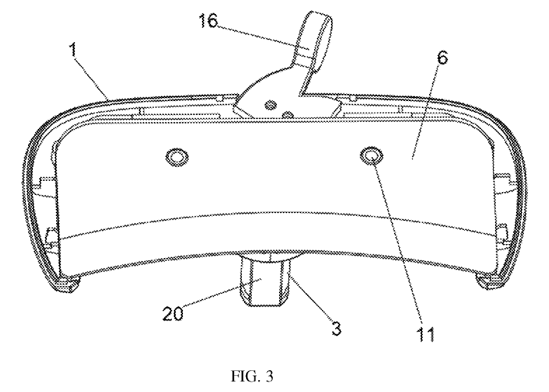

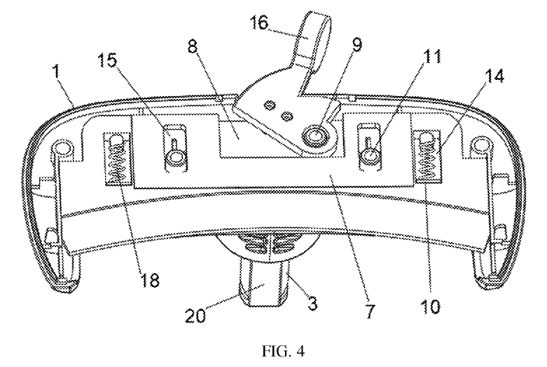

As shown in FIG. 3, FIG. 4, and FIG. 7, in an embodiment of the present disclosure, a positioning surface 20 is arranged on the side wall of the first connection portion 3, and a cross-sectional shape of the first connection portion 3 conforms to a cross-sectional shape of the connection groove 5.

The positioning surface 20 is arranged on the side wall of the first connection portion 3, and the cross-sectional shape of the first connection portion 3 conforms to the cross-sectional shape of the connection groove 5, so that after the first connection portion 3 is inserted into the connection groove 5, the first connection portion 3 can be prevented from rotating with the arrangement of the positioning surface 20. Furthermore, the position where the first connection portion 3 can be inserted into the connection groove 5 may be accurately determined by the positioning surface 20, ensuring that positions of the two limiting grooves 19 and the locking structure correspond to each other, and that the locking structure can work normally.

The present disclosure has the following advantages.

1. With the arrangement of the adjustment assembly on the comb body 1, the hair may be gathered at the end portion of the comb-tooth member 6, thereby reducing the difficulty of hair collection by the user.

2. The spring 18 is arranged inside the adjustment assembly, and after the adjustment assembly pushes the hair to the end portion of the comb-tooth member 6, when the adjustment assembly is released, the adjustment assembly may automatically return to the original position, making operation simpler and more convenient.

3. The fourth slide groove 15 is provided on the sliding member 7, and the third fixing member 11 extending through the fourth slide groove 15 is arranged in the comb body 1, so that the stability of the sliding member 7 may be improved.

In the present disclosure, the terms "mounted", "connected", "coupled", "fixed", or the like, are used in a broad sense, and for example, "coupled" may be fixed coupling, detachable coupling, or integral coupling, "connected" may be a direct connection or an indirect connection via an intermediate. The above terms can be understood by those skilled in the art according to specific situations.

In the description of the present disclosure, it should be understood that, directions or positional relationships indicated by terms "inner", "outer" etc. are based on orientations or positional relationships shown in the accompanying drawings, and they are used only for describing the present disclosure and for description simplicity, but do not indicate or imply that an indicated device or unit must have a specific direction or be constructed and operated in a specific orientation. Therefore, it cannot be understood as a limitation on the present disclosure.

In the description of the specification, descriptions of terms "an embodiment", "some embodiments", "a specific embodiment", or the like, means that a particular feature, structure, material, or characteristic described in connection with the embodiment or example is included in at least one embodiment or example of the present disclosure. In the specification, the schematic expressions to the above-mentioned terms are not necessarily referring to the same embodiment or example. Furthermore, the described particular features, structures, materials, or characteristics may be combined in any suitable manner in one or more embodiments or examples.

The above description is only preferred embodiments of the present disclosure and is not intended to limit the present disclosure, and various modifications and changes may be made to the present disclosure by those skilled in the art. Any modification, equivalent replacement, or improvement made within the spirit and principle of the present disclosure shall be included in the protection scope of the present disclosure.

What is claimed is:

1. A pet comb, comprising:
a comb body, wherein an accommodating cavity is provided in the comb body, and an opening is provided at a first end of the comb body;
a first connection portion, wherein the first connection portion is connected to a side of the comb body;
a second connection portion, wherein a connection groove is provided in the second connection portion, and the first connection portion is slidably connected to an interior of the connection groove;
a comb-tooth member, wherein a first end of the comb-tooth member is arranged in the accommodating cavity, and a second end of the comb-tooth member extends out through the opening;
a sliding member, wherein a first end of the sliding member is arranged in the accommodating cavity, a second end of the sliding member is configured to extend out through the opening, and the sliding member is in contact with the comb-tooth member; and
an adjustment assembly, wherein the adjustment assembly is arranged in the accommodating cavity.

2. The pet comb according to claim 1, wherein
the adjustment assembly comprises:
a groove, wherein the groove is provided on a side of the sliding member adjacent to the comb-tooth member and is arranged at the first end of the sliding member away from the opening;
a first fixing member, wherein a first end of the first fixing member is connected to an inner wall of the comb body, and a second end of the first fixing member extends through the sliding member and the comb-tooth member;
a first slide groove, wherein the first slide groove is provided at a bottom of the groove, and the first fixing member extends through the first slide groove;
a second slide groove, wherein the second slide groove is provided at the bottom of the groove;
an adjustment member, wherein a first end of the adjustment member is arranged in the groove and is rotatably connected to the first fixing member, a protrusion is connected to a side of the adjustment member away from the comb-tooth member and is slidably connected to an interior of the second slide groove, and a second end of the adjustment member extends through a second end of the comb body away from the opening;
a third slide groove, wherein the third slide groove is provided on the sliding member;
a second fixing member, wherein the second fixing member is connected to the inner wall of the comb body and extends through the third slide groove; and
a spring, wherein a first end of the spring is connected to a side wall of the third slide groove, and a second end of the spring is connected to the second fixing member.

3. The pet comb according to claim 2, wherein
a third fixing member is fixedly connected to the inner wall of the comb body, a fourth slide groove is provided on the sliding member, the third fixing member extends through the fourth slide groove and the comb-tooth member, and the third fixing member is slidably connected to an interior of the fourth slide groove.

4. The pet comb according to claim 1, wherein
a limiting groove is provided on a side wall of the first connection portion, a locking structure is arranged inside the connection groove, and the limiting groove is configured to be engaged with the locking structure.

5. The pet comb according to claim 1, wherein
a positioning surface is arranged on a side wall of the first connection portion, and a cross-sectional shape of the first connection portion conforms to a cross-sectional shape of the connection groove.
